(19) United States
(12) Patent Application Publication
(10) Pub. No.: US 2023/0069913 A1
(43) Pub. Date: Mar. 9, 2023

(54) MULTI-OBJECTIVE MACHINE LEARNING WITH MODEL AND HYPERPARAMETER OPTIMIZATION FUSION

(71) Applicant: International Business Machines Corporation, Armonk, NY (US)

(72) Inventors: Aswin Kannan, Chennai (IN); Vaibhav Saxena, New Delhi (IN); Anamitra Roy Choudhury, New Delhi (IN); Yogish Sabharwal, Gurgaon (IN); Parikshit Ram, Atlanta, GA (US); Ashish Verma, Nanuet, NY (US); Saurabh Manish Raje, Salt Lake City, UT (US)

(21) Appl. No.: 17/470,763

(22) Filed: Sep. 9, 2021

(51) Int. Cl. G06N 20/00

(52) U.S. Cl. CPC G06N 20/00

(57) ABSTRACT

Techniques for utilizing model and hyperparameter optimization for multi-objective machine learning are disclosed. In one example, a method comprises the following steps. One of a plurality of hyperparameter optimization operations and a plurality of model parameter optimization operations are performed to generate a first solution set. The other of the plurality of hyperparameter optimization operations and the plurality of model parameter optimization operations are performed to generate a second solution set. At least a portion of the first solution set and at least a portion of the second solution set are combined to generate a third solution set.

### BACKGROUND

Machine learning is a form of artificial intelligence that enables a system to learn from data rather than through explicit programming. Machine learning problems in various domains are often inherently multi-objective, requiring a model to simultaneously perform well with respect to multiple objectives f₁, . . . , fₘ. By way of example only, in classification problems with imbalanced classes (e.g., common in finance domains), it is desirable for the model to have high accuracy as well as high precision. Computer vision applications often require both high accuracy and (adversarial) robustness. Machine translation problems often desire models that simultaneously possess high evaluation metric scores. This necessitates multi-objective optimization (MOO) of relevant variables z∈Z of the learning problem defined as:

$${min}_{z ∈ Z ⊂ {ℝ}^{d}} F ( z ) = \{ {f}_{1} ( z ) , … , {f}_{m} ( z ) \} .$$

These optimization problems do not generally have a single solution, but a family of solutions, usually denoted by a Pareto-efficient frontier (or Pareto front) in the space of objectives [symbol] ⊂ [symbol] ^{m} that corresponds to the best trade-offs between the objectives. The Pareto front consists of a set of non-dominated points called Pareto solutions—for any two Pareto solutions z₁* and z₂*, there exist i,j∈[m]={1, . . . , m} such that fᵢ(z₁*)<fᵢ(z₂*) and fⱼ(z₁*)>fⱼ(z₂*). The Pareto front provides the user with useful insights into the problem, and lets the user select different solutions on the Pareto frontier based on the current requirements at hand. However, current machine learning optimization approaches suffer from various challenges as will be further mentioned herein.

### SUMMARY

Embodiments of the invention provide techniques for utilizing model and hyerparameter optimization for multi-objective machine learning.

In one illustrative embodiment, a method comprises the following steps. One of a plurality of hyperparameter optimization operations and a plurality of model parameter optimization operations are performed to generate a first solution set. The other of the plurality of hyperparameter optimization operations and the plurality of model parameter optimization operations are performed to generate a second solution set. At least a portion of the first solution set and at least a portion of the second solution set are combined to generate a third solution set.

Further illustrative embodiments are provided in the form of a computer program product comprising a non-transitory computer-readable storage medium having embodied therein executable program code that when executed by a processor causes the processor to perform the above steps. Still further illustrative embodiments comprise an apparatus or system with a processor and a memory configured to perform the above steps.

These and other features and advantages of embodiments described herein will become more apparent from the accompanying drawings and the following detailed description.

### BRIEF DESCRIPTION OF THE DRAWINGS

FIG. 1 illustrates an operational flow for multi-objective machine learning according to an illustrative embodiment.

FIG. 2 illustrates a system for multi-objective machine learning according to an illustrative embodiment.

FIG. 3 depicts a graph illustrating a Pareto frontier from a combination of hyperparameter optimization and model parameter optimization operations according to an illustrative embodiment.

FIG. 4 illustrates a multi-objective machine learning process flow according to an illustrative embodiment.

FIG. 5 illustrates an exemplary information processing system according to an illustrative embodiment.

FIG. 6 illustrates a cloud computing environment according to an illustrative embodiment.

FIG. 7 illustrates abstraction model layers according to an illustrative embodiment.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass a wide variety of processing system, by way of example only, processing systems comprising cloud computing and storage systems as well as other types of processing systems comprising various combinations of physical and/or virtual processing resources.

As mentioned above in the background section, current machine learning optimization approaches suffer from various challenges. For example, there are difficulties when simultaneously attempting to optimize more than one objective function, in that the best value for one objective function may not be a good value for another objective function. Objectives corresponding to the objective functions may comprise, for example, accuracy (classification error), precision, recall, computation time, false positive rate, false negative rate, Matthews Correlation Coefficient (MCC), etc.

Hyperparameter optimization (HPO) is performed in machine learning to find hyperparameters of a machine learning algorithm that result in the best performance of the algorithm. HPO is performed to identify hyperparameter combinations that result in the reduction of a standard pre-defined loss function for a given data set. Hyperparameters control the learning process, and may be defined prior to training. Some examples of hyperparameters include, but are not necessarily limited to, machine learning model size, a machine learning model learning rate and a machine learning model component size. Hyperparameters include model hyperparameters and algorithmic hyperparameters. Model hyperparameters define the structure of a machine learning model and algorithmic hyperparameters provide constraints in connection with machine learning model training. In more detail, some model hyperparameters that may be specified are, in the case of neural networks, the number of layers, number of neurons in each layer, choice of activation functions, and the layer structure (e.g., dense, sparse, flattening etc.), and in the case of gradient boosted decision trees, the number of decision trees and the number of leaves on each decision tree. Other model hyperparameters may include C (error control) and γ (model curvature) values for support vector machines (SVMs) and the “k” value in k-nearest neighbor (KNN) algorithm. Some algorithmic hyperparameters comprise, for example, in the case of neural networks, epochs and solvers used for gradient descent, learning rate for training, and, in the case of gradient boosted decision trees, child weight, lambda factor, subsample and learning rate for training.

Model parameter optimization (MPO) is performed in machine learning to find model parameters of a machine learning algorithm that result in the best performance of the algorithm. MPO comprises training a machine learning model, and as a result of the training, identifying model parameter values, which minimize an objective function over a given data set. Some examples of model parameters include, but are not necessarily limited to, machine learning model nodal weights, machine learning model biases (e.g., neural network biases) and machine learning model coefficients (e.g., neural network coefficients).

In multiobjective settings, current approaches utilizing HPO are limited in the variety of solutions which they can provide. They do not provide the ability to refine the solutions and may yield hyperparameter configurations which result in large amounts of model training and inference time. Current approaches utilizing MPO require deep apriori knowledge of a problem and model in order to choose hyperparameter configurations, and do not have the ability to consider multiple hyperparameter configurations.

Illustrative embodiments address the above and other challenges by providing techniques for utilizing both MPO and HPO for multi-objective machine learning. In more detail HPO and MPO methods are combined in such a way to yield a Pareto frontier including a variety of non-dominated points in hyperparameter and model parameter spaces. In one or more embodiments, HPO is performed on a space of objectives to generate a first solution set comprising a plurality of different hyperparameter configurations. MPO is performed on a subset of the hyperparameter configurations to generate a second solution set comprising a plurality of Pareto frontiers based on the MPO performed on the subset of the hyperparameter configurations. A Pareto frontier corresponding to the plurality of different hyperparameter configurations generated by the HPO is combined with the plurality of Pareto frontiers based on the MPO performed on the subset of the hyperparameter configurations to generate a fused Pareto frontier based on the combination of the HPO and MPO techniques. Advantageously, the embodiments can be performed in any order of HPO and MPO (e.g., serially, back and forth, and feedback-based). Additionally, reductions in processing time without sacrificing quality of results can be achieved by, for example, utilizing less computationally complex subsets from HPO.

As an additional advantage, the embodiments are applicable to multiple types of machine learning models including, but not necessarily limited to, decision trees (e.g., light gradient boosting machine (LGBM), XGBoost, Random Forest), SVMs, neural networks (e.g., deep neural networks (DNNs), convolutional neural networks (CNNs)), Gaussian estimators and multi-layer perceptron (MLP). The embodiments are also applicable to metrics associated with closed form expressions or blackbox functions. For example, the embodiments are used in connection with metrics including, but not necessarily limited to, precision, recall, F1 scores, accuracy, correlation coefficients, false positive rate, false negative rate, MCC and area under the curve of receiver characteristic operator (AUC-ROC). Gradients (closed form or automatic differentiation) may be deployed when possible, which does not occur with former approaches that use standard surrogate losses.

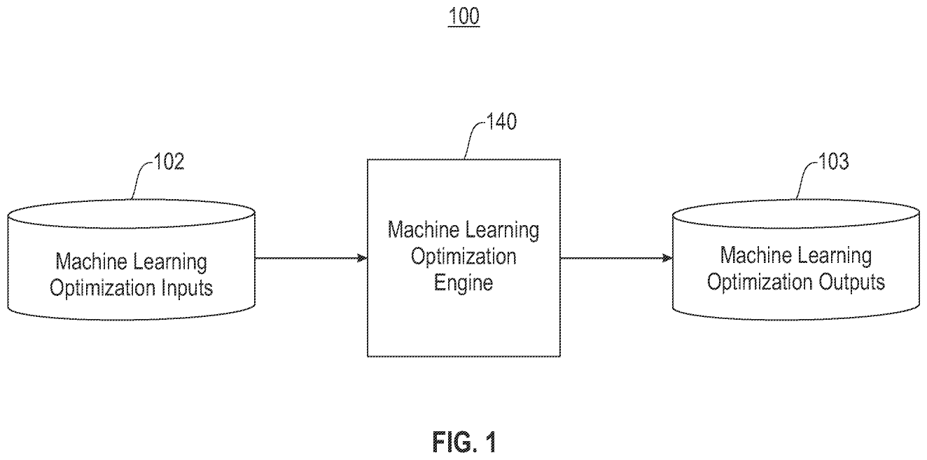

FIG. 1 depicts a machine learning optimization engine 140 and information processing system environment 100 according to an illustrative embodiment. As shown, machine learning optimization inputs 102 are input to the machine learning optimization engine 140. Machine learning optimization engine 140 processes the machine learning optimization inputs 102 to generate machine learning optimization outputs 103 that are representative of the machine learning optimization inputs 102. As will be further explained in more detail herein, the machine learning optimization inputs 102 comprise training data, algorithmic and model hyperparameters to be optimized, optimization metrics, user specified restrictions on hyperparameter values and time and/or computational complexity budgets. According to one or more embodiments, the machine learning optimization engine 140 executes an HPO routine, selects a subset of the hyperparameter configurations from the HPO routine and executes MPO routines on the subset. The machine learning optimization engine 140 combines the results of the HPO and MPO routines to generate the machine learning optimization outputs 103 comprising a Pareto frontier of pareto-optimal metrics and models, including optimal hyperparameters and model parameters based on the machine learning optimization inputs 102.

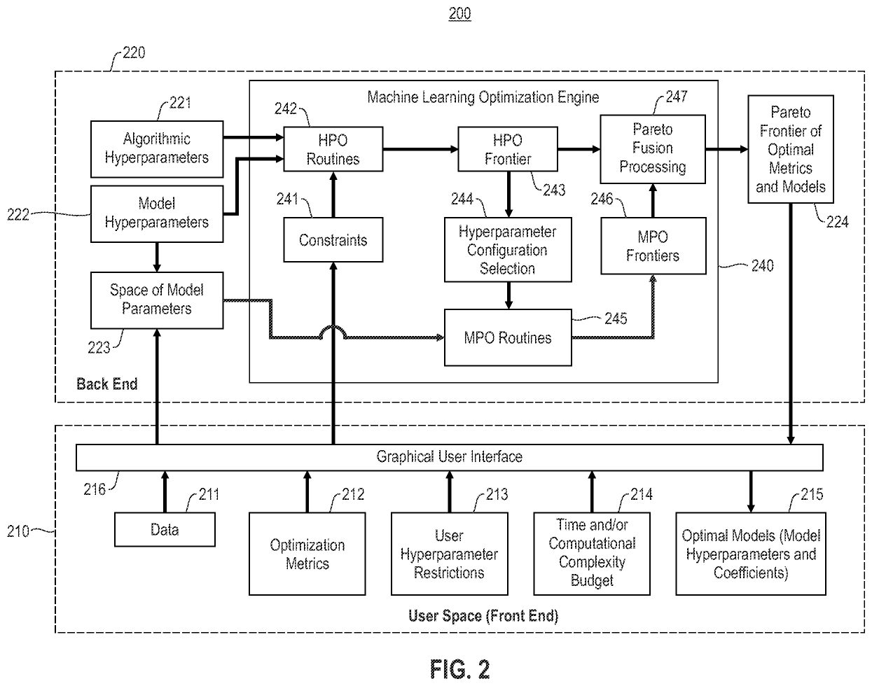

FIG. 2 is block diagram illustrating an information processing system 200 for multi-objective machine learning, according to an exemplary embodiment. As shown in FIG. 2 by lines and/or arrows, the components of the system 200 are operatively connected to each other via, for example, physical connections, such as wired and/or direct electrical contact connections, and/or wireless connections, such as, for example, WiFi, BLUETOOTH, IEEE 802.11, and/or other networks, including but not limited to, a local area network (LAN), wide area network (WAN), cellular network, ad hoc networks (e.g., wireless ad hoc network (WANET)), satellite network or the Internet. For example, a network can operatively link the user space (front end) 210 to the back end 220 and the components thereof.

By way of non-limiting example, in accordance with an embodiment of the present invention, referring to FIG. 2, a user, via an appropriate user interface such as, for example, a graphical user interface (GUI) 216 on a user device, inputs training data 211, optimization metrics 212, user hyperparameter restrictions 213 and time and/or computational complexity budgets 214 to a back end 220 comprising a machine learning optimization engine 240, which can be the same or similar to the machine learning optimization engine 140 discussed in connection with FIG. 1. The user device can include, but is not necessarily limited to a personal computer (PC), portable computer, and/or smart mobile device, such as a smart phone or tablet that can, for example, transmit inputs to the back end 220 via a network. The user device can be configured to communicate wirelessly with the machine learning optimization engine 240 and other components of the back end 220 over the network. Algorithmic and model hyperparameters 221 and 222, and the space of model parameters 223 are input to the machine learning optimization engine 240 at the back end 220. In one or more embodiments, the algorithmic and model hyperparameters 221 and 222 can be input to the backend via a user device and GUI 216 from the front end 210. The space of model parameters 223 is a consequence of the algorithmic and model hyperparameters 221 and 222 and is not a direct user input.

The training data 211 comprises one or more data sets that are used to train a machine learning model. The training data can be complemented by additional sets of data such as, for example, validation and testing data sets. The training data 211 will vary to correspond to the type of problems the machine learning model is designed to address. As noted herein, the optimization metrics 212 comprise metrics associated with closed form expressions and/or blackbox functions. For example, the optimization metrics 212 comprise, but are not necessarily limited to, precision, recall, F1 scores, accuracy, correlation coefficients, false positive rate, false negative rate, MCC and area under the curve of receiver characteristic operator (AUC-ROC). Closed form and/or automatic differentiation gradients may be deployed when possible. Additional optimization metrics 212 comprise, for example, specified types of loss to be used in connection with optimization, like cross-entropy loss, hinge loss, softmax loss or other type of loss. Examples of blackbox functions include training time and computational complexity.

The user hyperparameter restrictions 213 comprise, for example, user-specified constraints on hyperparameters, such as, for example, ceilings and/or floors for machine learning model elements (e.g., the number of layers and number of neurons in a neural network, the number of decision trees in gradient boosted trees, etc.). A non-limiting example of a user hyperparameter restriction 213 is that the number of neurons or decision trees shall not exceed a given numerical value.

Time and/or computational complexity budget 214 refers to, for example, specified constraints on the amount of time and/or computational resources to be taken for training, MPO and/or HPO. For example, a user may specify a given number of seconds or percentage of total allocated time to be spent for HPO and/or MPO. A user may also specify computational load restrictions based on, for example, memory usage.

The hyperparameters input to the machine learning optimization engine 240 comprise algorithmic and model hyperparameters 221 and 222. As noted herein, the algorithmic hyperparameters 221 comprise, for example, in the case of neural networks, epochs and solvers used for descent, learning rate for training, and, in the case of gradient boosted decision trees, child weight, lambda factor, subsample and learning rate for training. The model hyperparameters 222 comprise, for example, in the case of neural networks, the number of layers, number of activation functions, number of hidden layers, number of neurons in each layer, and the layer structure (e.g., dense, sparse, flattening etc.), and in the case of gradient boosted decision trees, the number of decision trees and the number of leaves on each decision tree. As noted herein, other model hyperparameters may include C and y values for SVMs and the k value in a KNN algorithm.

The space of model parameters 223 refers to inputs comprising the model parameters and the search space of the model parameters. As noted above, the model parameters comprise, for example, machine learning model nodal weights, machine learning model biases (e.g., neural network biases) and machine learning model coefficients (e.g., neural network coefficients), which are learned through training. For example, the search space may comprise a weight space, where weights are learned over time, for example, by gradient descent or some other technique. Similarly, biases and coefficients may also be part of the search space and learned over time. The model parameter space refers to the space of possible parameter values that define a specific machine learning model. While the model parameters are not direct user inputs, their cardinality (e.g., the space of model parameters 223) changes depending on the constraints on model hyperparameters. This is reflected in the inputted user hyperparameter restrictions 213 from the GUI 216 that goes into block 223, which in turn leads to block 245 (MPO routines). The MPO routines 245, in turn, use the space of model parameters 223 for optimizing the model parameters.

According to one or more embodiments, the training data 211, optimization metrics 212, user hyperparameter restrictions 213 and time and/or computational complexity budget 214 have values that are fixed by a user prior to optimization by the machine learning optimization engine 240. The algorithmic and model hyperparameters 221 and 222 and the model hyperparameters may be modified as a result of the MPO and HPO performed by the machine learning optimization engine 240.

In one or more illustrative embodiments, based on the inputted algorithmic and model hyperparameters 221 and 222, and constraints 241 derived from the optimization metrics 212, user hyperparameter restrictions 213 and time and/or computational complexity budget 214, the machine learning optimization engine 240 performs HPO routines 242 and generates HPO Pareto frontier 243 from the HPO routines 242. The HPO routines 242 can be performed using one or more multi-objective HPO techniques such as, but not necessarily limited to Bayesian methods like Max-value Entropy Search for Multi-objective Optimization (MESMO) and Uncertainty-aware Search framework for Multi-objective Optimization (USeMO) or heuristic search schemes like Non-dominated Sorting Genetic Algorithm II (NSGA-II) techniques.

In an operational example, an HPO solver using one of the MESMO, USeMO, NSGA-II or other technique is initialized and an HPO time budget is fixed based on an inputted time budget 214. For example, the time budget for HPO (Tₕ) may be 15-30 percent of the total optimization time (T). HPO routines 242 are performed on the input data 211 using, for example, using a loss objective such as, for example, a cross-entropy loss objective, a hinge loss objective, a softmax loss objective and/or other loss objective. For example, for a given machine learning model (e.g., decision tree model, SVM, neural network, Gaussian estimator, MLP, etc.) a number of HPO evaluations are executed. Each respective evaluation corresponds to the same type/class of machine learning model (e.g., every evaluation is on a decision tree model) and uses different hyperparameters. Each respective evaluation is run over different hyperparameter decision variables and generates a solution set comprising a Pareto frontier (HPO frontier 243) based on a plurality of different hyperparameter configurations.

Based on the optimization metrics 212, the machine learning optimization engine 240 computes objectives of interest (e.g., false positive rate, recall, accuracy, MCC, etc.) for each respective hyperparameter configuration. Referring to block 244 for hyperparameter configuration selection, the machine learning optimization engine 240 selects a subset of the plurality of different hyperparameter configurations generated from the HPO routines 242. The selection is performed based on one or more selection metrics. In a non-limiting example, the selection metric can be based on total training time (e.g., as set forth, for example in an inputted time budget 214) and/or one or more of the objectives of interest (e.g., accuracy, false positive rate, recall, MCC, etc. as set forth in the inputted optimization metrics 212).

An example metric: {Training time−10×Classification Accuracy}, is inclusive of training time and accuracy. Based on the metric, the subset of the plurality of different hyperparameter configurations is selected and, referring to block 245, an MPO routine is performed on each respective configuration in the subset. For example, assuming the HPO yielded 100 hyperparameter configurations, a subset comprising the highest scoring hyperparameter configurations based on the metric is selected for MPO. A user may pre-determine how many configurations should be in the subset (e.g., top 40-50 configurations).

In one or more embodiments, metric selection is performed according to the following formula.

argminₓ[w·Lₚ(fᵢ(x))+(1−w)·T(x)]

Here, T(x) denotes the time taken for training the model and Lₚ(⋅) denotes the loss or error defined with respect to the metrics f(⋅). Examples of Lₚ(f) can be ∥f∥² (Euclidean Norm) or the Log Barrier function maxᵢ(−log(fᵢ)) for 0<=f(x)<=1.

According to an embodiment, MPO is executed for each of the configurations in the subset with custom objectives based on the inputted optimization metrics 212. In one or more embodiments, MPO is performed pursuant to a time cap (Total optimization time (T)−the time budget for HPO (Tₕ)). For example, while t<(T−Tₕ), MPO is run for the i^{th} configuration in the subset, and t=t+tᵢ, (where tᵢ denotes the total training time for the i^{th} configuration in the subset). For performing MPO each time, the model is trained on a custom loss that is an aggregation of the individual metrics of interest. The importance of each of these metrics towards the custom loss is varied adaptively based on the progression of the Pareto frontier (not chosen apriori as with conventional methods).

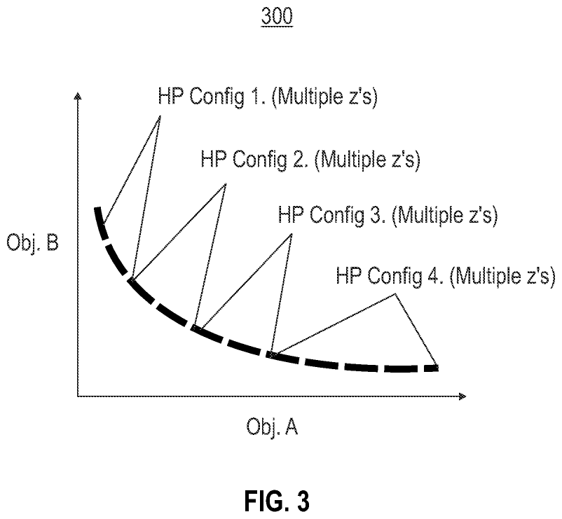

Following generation of the MPO Pareto frontiers 246 from the MPO being performed on the subset hyperparameter configurations, Pareto fusion processing 247 is performed to combine a Pareto frontier corresponding to the plurality of different hyperparameter configurations generated by the HPO (e.g., HPO frontier 243) with the MPO Pareto frontiers 246 to generate a fused Pareto frontier of optimal metrics and models 224. An example of the fused Pareto frontier 224 is shown in the graph 300 in FIG. 3. As shown in FIG. 3, the fused Pareto frontier 224 is generated in multiple model parameters (z) for each hyperparameter configuration (x) for multiple objectives (e.g., Obj. A and Obj. B). The resulting Pareto frontier 224 includes a plurality of non-dominated data points based on the plurality of hyperparameter configurations (x) and the multiple model parameters (z). Based on the fused Pareto frontier 224, the optimal models 215, including model hyperparameters and coefficients, are presented to user via, for example, the GUI 216 on a user device. In a non-limiting example, the output includes a list of optimal models varying in model hyperparameters and a subset of solutions varying in model coefficients for each of these hyperparameter configurations.

As explained herein, the embodiments provide techniques for combining HPO and MPO in multi-objective optimization, where both HPO and MPO utilize multi-objective optimization. Referred to herein as Hyper Adaptively Scalarized Pareto Optimization (HyperASPO) or fusion mechanism, the HPO routines 242 perform multi-objective HPO and then the MPO routines 245 employ ASPO on computationally efficient and promising hyperparameter configurations to efficiently generate high quality Pareto frontiers.

The machine learning optimization engine 240 provides a framework for simultaneously optimizing hyperparameters A and corresponding model parameters OA. Given a particular time and/or computational budget 214, the MPO operations are executed on the selected hyperparameter configurations and the respective resulting Pareto frontiers are combined.

In an example, embodiment, referring to the HPO routines 242, HPO is run for a given number k of evaluations to determine a set of favorable hyperparameter configurations. In an embodiment using training time as a metric, the obtained hyperparameter configurations are sorted in increasing order of the training time and the top configurations are selected for MPO operations to yield respective MPO frontiers 246, which are used for Pareto fusion processing 247.

Pseudocode for the fusion mechanism is presented as follows. The fusion (or HyperASPO) mechanism combines optimization over the spaces of both hyperparameters and model parameters (HPO+MPO) for multi-objective optimization.

1: Input: ASPO procedure A, HPO scheme H, maximum number k of evaluations, maximum number of hyperparameter configurations of H, time budget T for combined optimization.

2: Output: Pareto front for the MOO problem.

3: Perform HPO using H to determine a set of k favorable hyperparameter configurations.

4: Sort the obtained configurations in increasing order of the training time using the HPO scheme H.

5: Set i←1. Set t←Tₕ, where Tₕ is the time to run H.

6: while t<(T−Tₕ) do

7: Run A for configuration i in the sorted list.

8: t←t+tᵢ, where tᵢ denotes the training time of A for configuration i.

9: i←i+1.

10: end while

11: Fusion: Combine all the i MPO frontiers with the HPO frontier and choose the non-dominated points to return the fused Pareto frontier.

In connection with the Pareto fusion processing 247, model training is performed for each weight combination, spanning the space between 0 and 1. Iterative and adaptive learning is performed from the function values “ƒ”. Model training is performed based on the scalarization f_{sc}. Note that the scalarization f_{sc} denotes the linearization of the individual custom functions or metrics (objectives of interest like accuracy error, precision error, and recall error).

minₓf_{sc}(x)={w₁f₁(x)+w₂f₂(x)+ . . . +w_{M}f_{M}(x)}

Subject to x∈X

Given that larger hypervolumes indicate better results (e.g., more desirable Pareto frontiers) than lesser hypervolumes, the fusion technique of the embodiments when compared with current approaches results in improvements in hypervolume. Additionally, the larger hypervolumes are achieved relatively quickly and in many cases faster than with conventional approaches. Moreover, maximum hypervolumes that may be obtained by conventional approaches are achieved faster when using the fusion technique of the embodiments.

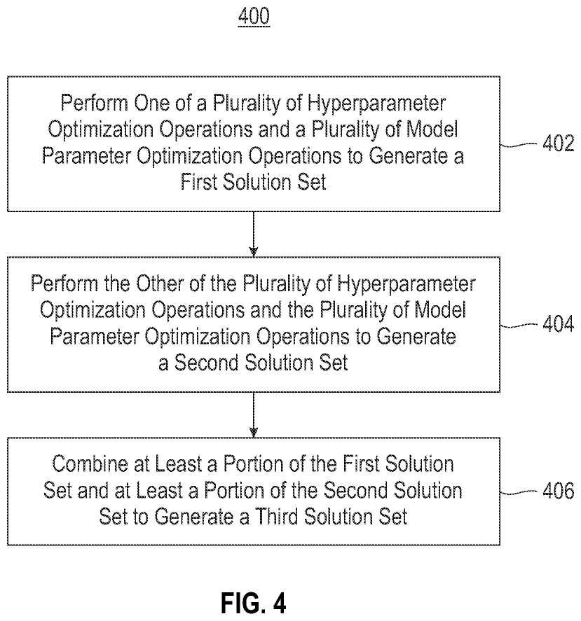

Accordingly, taking into account the above and other features described herein, FIG. 4 illustrates a multi-objective machine learning methodology 400 that combines HPO and MPO to produce an improved Pareto frontier for multiple objectives.

In step 402, one of a plurality of HPO operations and a plurality of MPO operations are performed to generate a first solution set. In step 404, the other of the plurality of HPO operations and the plurality of MPO operations are performed to generate a second solution set. In step 406, at least a portion of the first solution set and at least a portion of the second solution set are combined to generate a third solution set. For example, in an embodiment, a plurality of HPO operations are performed, which generate a first solution set comprising a plurality of hyperparameter configurations. A subset of the plurality of hyperparameter configurations is selected and a plurality of MPO operations are performed on the subset to generate the second solution set. A Pareto frontier corresponding to the first solution is generated and combined with Pareto frontiers resulting from the plurality of MPO operations to generate a fused Pareto frontier comprising the third solution set. The fused Pareto frontier comprises a plurality of non-dominated data points.

The selection of the subset of the first solution set (e.g., the subset of a plurality of different hyperparameter configurations) is based at least in part on one or more selection metrics comprising at least one of a training time and one or more objectives of interest. As noted herein, a few examples for objectives of interest are false positive rate, recall, accuracy and MCC.

As noted herein, the plurality of hyperparameters comprise one or more of a machine learning model size, a machine learning model learning rate and a machine learning model component size, and the plurality of model parameters comprise one or more of machine learning model nodal weights, machine learning model biases and machine learning model coefficients. The plurality of MPO operations are performed using one or more adaptive weights and one or more custom objectives.

The plurality of HPO operations are performed using, for example, a cross-entropy loss objective, a hinge loss objective and a softmax loss objective, and are performed without constraints or with one or more user-defined constraints. The HPO and MPO operations are iteratively executed, and not necessarily serially executed.

The techniques depicted in FIGS. 1-4 can also, as described herein, include providing a system, wherein the system includes distinct software modules, each of the distinct software modules being embodied on a tangible computer-readable recordable storage medium. All of the modules (or any subset thereof) can be on the same medium, or each can be on a different medium, for example. The modules can include any or all of the components shown in the figures and/or described herein. In an embodiment of the invention, the modules can run, for example, on a hardware processor. The method steps can then be carried out using the distinct software modules of the system, as described above, executing on a hardware processor. Further, a computer program product can include a tangible computer-readable recordable storage medium with code adapted to be executed to carry out at least one method step described herein, including the provision of the system with the distinct software modules.

Additionally, the techniques depicted in FIGS. 1-4 can be implemented via a computer program product that can include computer useable program code that is stored in a computer readable storage medium in a data processing system, and wherein the computer useable program code was downloaded over a network from a remote data processing system. Also, in an embodiment of the invention, the computer program product can include computer useable program code that is stored in a computer readable storage medium in a server data processing system, and wherein the computer useable program code is downloaded over a network to a remote data processing system for use in a computer readable storage medium with the remote system.

An embodiment of the invention or elements thereof can be implemented in the form of an apparatus including a memory and at least one processor that is coupled to the memory and configured to perform exemplary method steps.

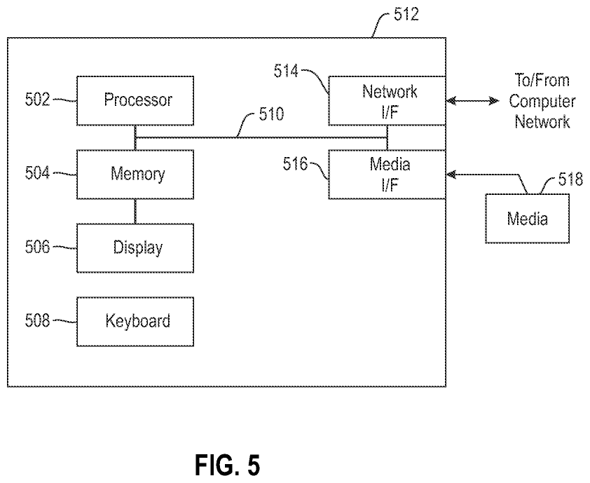

Additionally, an embodiment of the present invention can make use of software running on a computer or workstation. With reference to FIG. 5, such an implementation might employ, for example, a processor 502, a memory 504, and an input/output interface formed, for example, by a display 506 and a keyboard 508. The term “processor” as used herein is intended to include any processing device, such as, for example, one that includes a multi-core CPU, GPU, FPGA and/or other forms of processing circuitry such as one or more ASICs. Further, the term “processor” may refer to more than one individual processor. The term “memory” is intended to include memory associated with a processor (e.g., CPU, GPU, FPGA, ASIC, etc.) such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, a mechanism for inputting data to the processing unit (for example, mouse), and a mechanism for providing results associated with the processing unit (for example, printer). The processor 502, memory 504, and input/output interface such as display 506 and keyboard 508 can be interconnected, for example, via bus 510 as part of a data processing unit 512. Suitable interconnections, for example via bus 510, can also be provided to a network interface 514, such as a network card, which can be provided to interface with a computer network, and to a media interface 516, such as a diskette or CD-ROM drive, which can be provided to interface with media 518.

Accordingly, computer software including instructions or code for performing the methodologies of embodiments of the invention, as described herein, may be stored in associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 502 coupled directly or indirectly to memory elements 504 through a system bus 510. The memory elements can include local memory employed during actual implementation of the program code, bulk storage, and cache memories which provide temporary storage of at least some program code in order to reduce the number of times code must be retrieved from bulk storage during implementation.

Input/output or I/O devices (including, but not limited to, keyboards 508, displays 506, pointing devices, and the like) can be coupled to the system either directly (such as via bus 510) or through intervening I/O controllers (omitted for clarity).

Network adapters such as network interface 514 may also be coupled to the system to enable the data processing system to become coupled to other data processing systems or remote printers or storage devices through intervening private or public networks. Modems, cable modems and Ethernet cards are just a few of the currently available types of network adapters.

As used herein, including the claims, a “server” includes a physical data processing system (for example, system 512 as shown in FIG. 5) running a server program. It will be understood that such a physical server may or may not include a display and keyboard.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It should be noted that any of the methods described herein can include an additional step of providing a system comprising distinct software modules embodied on a computer readable storage medium; the modules can include, for example, any or all of the components detailed herein. The method steps can then be carried out using the distinct software modules and/or sub-modules of the system, as described above, executing on a hardware processor 502. Further, a computer program product can include a computer-readable storage medium with code adapted to be implemented to carry out at least one method step described herein, including the provision of the system with the distinct software modules.

In any case, it should be understood that the components illustrated herein may be implemented in various forms of hardware, software, or combinations thereof, for example, application specific integrated circuit(s) (ASICs), functional circuitry, an appropriately programmed digital computer with associated memory, and the like. Given the teachings of the invention provided herein, one of ordinary skill in the related art will be able to contemplate other implementations of the components of the invention.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (for example, country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (for example, storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (for example, web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (for example, host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (for example, mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (for example, cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

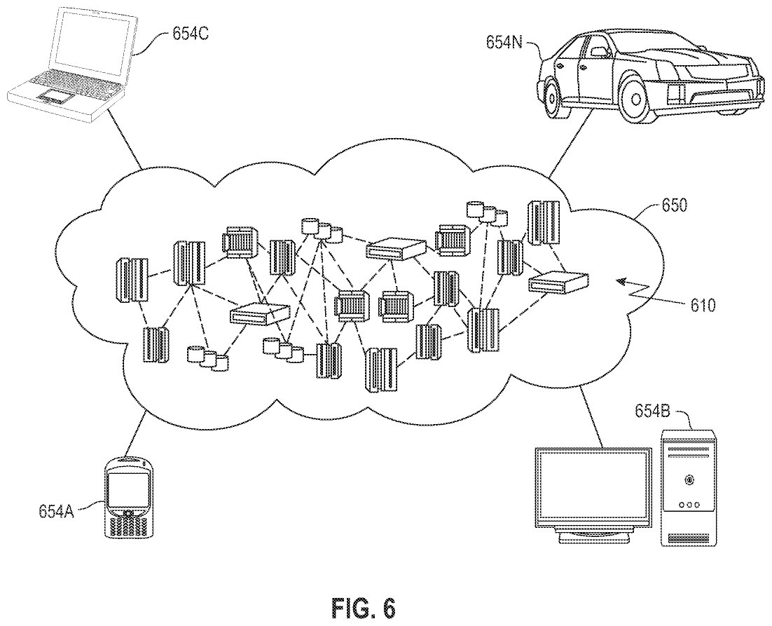

Referring now to FIG. 6, illustrative cloud computing environment 650 is depicted. As shown, cloud computing environment 650 includes one or more cloud computing nodes 610 with which local computing devices used by cloud consumers, such as, for example, personal digital assistant (PDA) or cellular telephone 654A, desktop computer 654B, laptop computer 654C, and/or automobile computer system 654N may communicate. Nodes 610 may communicate with one another. They may be grouped (not shown) physically or virtually, in one or more networks, such as Private, Community, Public, or Hybrid clouds as described hereinabove, or a combination thereof. This allows cloud computing environment 650 to offer infrastructure, platforms and/or software as services for which a cloud consumer does not need to maintain resources on a local computing device. It is understood that the types of computing devices 654A-N shown in FIG. 6 are intended to be illustrative only and that computing nodes 610 and cloud computing environment 650 can communicate with any type of computerized device over any type of network and/or network addressable connection (e.g., using a web browser).

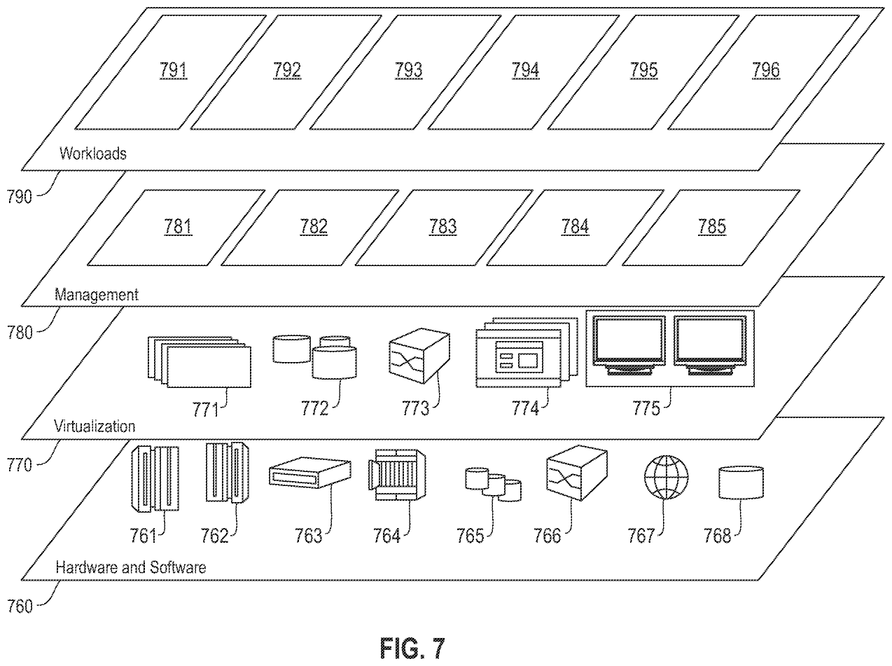

Referring now to FIG. 7, a set of functional abstraction layers provided by cloud computing environment 650 (FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 760 includes hardware and software components. Examples of hardware components include: mainframes 761; RISC (Reduced Instruction Set Computer) architecture-based servers 762; servers 763; blade servers 764; storage devices 765; and networks and networking components 766. In some embodiments, software components include network application server software 767 and database software 768.

Virtualization layer 770 provides an abstraction layer from which the following examples of virtual entities may be provided: virtual servers 771; virtual storage 772; virtual networks 773, including virtual private networks; virtual applications and operating systems 774; and virtual clients 775. In one example, management layer 780 may provide the functions described below. Resource provisioning 781 provides dynamic procurement of computing resources and other resources that are utilized to perform tasks within the cloud computing environment. Metering and Pricing 782 provide cost tracking as resources are utilized within the cloud computing environment, and billing or invoicing for consumption of these resources.

In one example, these resources may include application software licenses. Security provides identity verification for cloud consumers and tasks, as well as protection for data and other resources. User portal 783 provides access to the cloud computing environment for consumers and system administrators. Service level management 784 provides cloud computing resource allocation and management such that required service levels are met. Service Level Agreement (SLA) planning and fulfillment 785 provide pre-arrangement for, and procurement of, cloud computing resources for which a future requirement is anticipated in accordance with an SLA.

Workloads layer 790 provides examples of functionality for which the cloud computing environment may be utilized. Examples of workloads and functions which may be provided from this layer include: mapping and navigation 791; software development and lifecycle management 792; virtual classroom education delivery 793; data analytics processing 794; transaction processing 795; and multi-objective machine learning processing 796, in accordance with the one or more embodiments of the present invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of another feature, step, operation, element, component, and/or group thereof.

At least one embodiment of the present invention may provide a beneficial effect such as, for example, a framework (e.g., a set of one or more framework configurations) for multi-objective machine learning processing that replaces current approaches which perform single-objective optimization. The embodiments provide techniques to combine HPO and MPO by using one or more metrics to select a subset of HPO operation results to use in MPO operations. The embodiments also advantageously include techniques to give time to complete optimization and/or computational load higher consideration than incremental improvements in accuracy.

As an additional advantage, the embodiments provide for simultaneous resolution of multiple metrics and objectives, and reduce false negatives and false positives, while providing more accurate solutions based on a combination of MPO and HPO techniques than conventional approaches which may rely solely on MPO or solely on HPO, with no techniques for fusing frontiers across model parameters and hyperparameters. In one or more illustrative embodiments, the framework is a cloud-based framework and platform for multi-objective machine learning processing.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. An apparatus comprising:
at least one processing device comprising a processor coupled to a memory, the at least one processing device, when executing program code, is configured to:
perform one of a plurality of hyperparameter optimization operations and a plurality of model parameter optimization operations to generate a first solution set;
perform the other of the plurality of hyperparameter optimization operations and the plurality of model parameter optimization operations to generate a second solution set; and
combine at least a portion of the first solution set and at least a portion of the second solution set to generate a third solution set.

2. The apparatus of claim 1, wherein the other of the plurality of hyperparameter optimization operations and the plurality of model parameter optimization operations is performed on a subset of the first solution set.

3. The apparatus of claim 2, wherein the other of the plurality of hyperparameter optimization operations and the plurality of model parameter optimization operations comprises the plurality of model parameter optimization operations and the subset comprises a plurality of different hyperparameter configurations.

4. The apparatus of claim 2, wherein the at least one processing device, when executing program code, is further configured to select the subset of the first solution set based at least in part on one or more selection metrics.

5. The apparatus of claim 4, wherein the one or more selection metrics comprise at least one of a training time and one or more objectives of interest.

6. The apparatus of claim 5, wherein the one or more objectives of interest comprise at least one of false positive rate, recall and accuracy.

7. The apparatus of claim 1, wherein the at least one processing device, when executing program code, is further configured to select one or more non-dominated data points for a Pareto frontier.

8. The apparatus of claim 1, wherein the plurality of hyperparameter optimization operations are performed using a plurality of hyperparameters, the plurality of hyperparameters comprising one or more of a machine learning model size, a machine learning model learning rate and a machine learning model component size.

9. The apparatus of claim 1, wherein the plurality of model optimization operations are performed using a plurality of model parameters, the plurality of model parameters comprising one or more of machine learning model nodal weights, machine learning model biases and machine learning model coefficients.

10. The apparatus of claim 1, wherein the plurality of hyperparameter optimization operations are performed using a multi-objective hyperparameter optimization technique.

11. The apparatus of claim 1, wherein the plurality of hyperparameter optimization operations are performed using one of a cross-entropy loss objective, a hinge loss objective and a softmax loss objective.

12. The apparatus of claim 1, wherein the plurality of hyperparameter optimization operations are performed one of without constraints and with one or more user-defined constraints.

13. The apparatus of claim 1, wherein the plurality of model optimization operations are performed using at least one of one or more adaptive weights and one or more custom objectives.

14. The apparatus of claim 1, wherein the performing of the one of and the other of the plurality of hyperparameter optimization operations and the plurality of model parameter optimization operations is iteratively executed.

15. A method comprising:
performing one of a plurality of hyperparameter optimization operations and a plurality of model parameter optimization operations to generate a first solution set;
performing the other of the plurality of hyperparameter optimization operations and the plurality of model parameter optimization operations to generate a second solution set; and
combining at least a portion of the first solution set and at least a portion of the second solution set to generate a third solution set;
wherein the steps are performed by at least one processing device comprising a processor coupled to a memory when executing program code.

16. The method of claim 15, wherein the other of the plurality of hyperparameter optimization operations and the plurality of model parameter optimization operations is performed on a subset of the first solution set.

17. The method of claim 16, wherein the other of the plurality of hyperparameter optimization operations and the plurality of model parameter optimization operations comprises the plurality of model parameter optimization operations and the subset comprises a plurality of different hyperparameter configurations.

18. A computer program product comprising a processor-readable storage medium having encoded therein executable code of one or more software programs, wherein the one or more software programs when executed by the one or more processors implement steps of:
performing one of a plurality of hyperparameter optimization operations and a plurality of model parameter optimization operations to generate a first solution set;
performing the other of the plurality of hyperparameter optimization operations and the plurality of model parameter optimization operations to generate a second solution set; and
combining at least a portion of the first solution set and at least a portion of the second solution set to generate a third solution set.

19. The computer program product of claim 18, wherein the other of the plurality of hyperparameter optimization operations and the plurality of model parameter optimization operations is performed on a subset of the first solution set.

20. The computer program product of claim 19, wherein the other of the plurality of hyperparameter optimization operations and the plurality of model parameter optimization operations comprises the plurality of model parameter optimization operations and the subset comprises a plurality of different hyperparameter configurations.
